(19) United States
(12) Patent Application Publication
(10) Pub. No.: US 2010/0197822 A1
(43) Pub. Date: Aug. 5, 2010

(54) REDUCED CREEP HIGH MOLECULAR WEIGHT POLYETHYLENE AND METHODS FOR FORMING THE SAME

(76) Inventors: Anthony B. Brennan, Gainesville, FL (US); Christopher D. Batich, Gainesville, FL (US)

Correspondence Address: CANTOR COLBURN, LLP, 20 Church Street, 22nd Floor, Hartford, CT, 06103, US

(21) Appl. No.: 12/095,526

(22) PCT Filed: Dec. 1, 2006
(86) PCT No.: PCT/US06/61489

§ 371 Date: Apr. 27, 2010

Related U.S. Application Data
(60) Provisional application No. 60/741,335, filed on Dec. 1, 2005.

(51) Int. Cl. C08J 3/28; C08F 255/02

(52) U.S. Cl. 522/125; 522/113; 525/55; 525/387

(57) ABSTRACT

A method for forming reduced creep high molecular weight polyethylene articles, involves irradiating a high molecular weight polyethylene fiber or block, where the polyethylene is polycrystalline with a preferred crystal orientation. The fiber or block is irradiated in an environment including a molecule with a dual reactive functionality to provide cross-linking in the amorphous regions and/or on the surface and an inert gas at a temperature that is below an average alpha transition temperature of the polyethylene. The irradiation can be carried out on a polyethylene fiber by drawing a fiber through a solution containing a grafting agent that can include a molecule with a dual reactive functionality to primarily apply and cross-link the grafting material to the surface of the fiber. The resulting high molecular weight polyethylene article is highly cross linked and includes a plurality of substantially aligned crystals, the article providing an X-ray diffraction pattern evidencing only 2 sharp reflections.

### FIELD OF THE INVENTION

The invention relates to cross-linked high molecular weight polyethylene articles, such as Ultra High Molecular Weight Polyethylene (UHMWPE) fibers, and methods for making or improving the same.

### BACKGROUND

Among the requirements that protective clothing such as personal body armor, chain saw chaps, and others must meet, in addition to ballistic-resistance and/or cut resistance, are comfort and flexibility. Multiple layers of woven fabrics consisting of high strength and high modulus fibers are required for use in such protective clothing.

In recent years, attempts have been made to obtain high-strength, high-elastic modulus fibers from ultrahigh molecular weight polyethylene (UHMWPE) starting material, and extremely high strength/elastic modulus fibers have been formed. For example, the “gel spinning method” technique, where gel-like fibers are obtained by dissolving ultrahigh molecular weight polyethylene in solvent and are drawn to a high draw ratio, has been used to form UHMWPE fibers. High strength polyethylene fibers obtained by the gel spinning method are generally very high in strength and elastic modulus as organic fibers, and are also highly superior in terms of impact resistance, and these fibers are being evermore widely used in various fields. However, these high strength polyethylene fibers undergo major changes in performance with temperature. For example, the tensile strength decreases as the temperature increases, particularly as temperatures approach or exceed the glass transition temperature (Tg) which is about −125 C for UHMWPE.

Polyethylenes are classified according to their density, which in turn depends on the extent and type of branching present in the material. The various classifications include UHMWPE (ultra high molecular weight PE), HDPE (high density PE), MDPE (medium density PE), LDPE (low density PE), and LLDPE (linear low density PE). LDPE has many more branches than HDPE, which means that the chains do not “fit well” together. It has therefore less strong intermolecular forces as the instantaneous-dipole induced-dipole attraction is less. This results in a lower density and tensile strength, increased malleability and faster biodegradation. LDPE is created by free radical polymerization. UHMWPE and HDPE has virtually no branching and thus stronger intermolecular forces and tensile strength. The lack of branching is ensured by an appropriate choice of catalyst (e.g. Ziegler catalysts) and reaction conditions.

UHMWPE is used extensively for the production of specialized ultra high modulus polyethylene fibers and marketed by Honeywell in the U.S. as SPECTRA® fibers (UHMPE fibers, Allied Signal, Inc.), and as DYNEEMA® fibers. The fiber forms of UHMWPE are used in applications as simple as fishing line and complex as bullet proof vest materials. The solid, molded forms derived from the fibers are either used directly or machined for wear surfaces in prosthetic devices. These materials offer superb strength to weight ratio but are generally inadequate for applications requiring static loads or mechanical applications due to their creep or slow deformation under loads exerted over long times.

Increased cross-link density in polyethylene is beneficial in bearing surface applications for joint arthroplasty because it significantly increases the wear resistance of this material. Radiation can be used to cross-link the UHMWPE. Cross-linking connects respective neighboring PE crystals to one another by covalent bonds by radiation treated UHMWPE is meant UHMWPE which has been treated with radiation, e.g., gamma radiation or electron radiation, so as to induce cross-links between the polymeric chains of the UHMWPE.

U.S. Pat. No. 6,852,772 to Muratoglu et al. issued Feb. 8, 2005 is entitled “High modulus cross-linked polyethylene with reduced residual free radical concentration prepared below the melt.” Muratoglu discloses an irradiated cross-linked polyethylene containing reduced free radicals, preferably containing substantially no residual free radical. The disclosed process for forming a cross-linked polyethylene composition comprises the steps of a) irradiating at a temperature that is below the melting point of the polyethylene; mechanically deforming the polyethylene below the melting point of the irradiated polyethylene in order to reduce the concentration of residual free radicals, and c) annealing the mechanically deformed polyethylene at a temperature below the polyethylene melting point in order to permit shape recovery.

Although the Muratoglu process is performed below the melting point of the PE, it is performed above the PE alpha transition temperature of about 90 to 95 C. Specifically, in col. 6 lines 12 to 27 Muratoglu discloses contacting the irradiated polyethylene with a sensitizing environment, and heating the polyethylene to above a critical temperature (said to likely be the alpha transition temperature of the polyethylene) that allows the free radicals to react with the sensitizing environment, but is still below the 145 C melting point of the polyethylene. According to Muratoglu, the alpha transition is believed to induce motion in the crystalline phase, which is believed to provide the desired increase the diffusion of the sensitizing environment into this phase and/or release the trapped free radicals allowing the free radicals to react with the sensitizing gas and/or liquid, which are discloses to act as a linking agent between adjacent free radicals.

The PE samples processed by Muratoglu begin with large PE blocks formed by an extrusion process having large diameters, such as UHMWPE bar stock of 3.5″diameter. The blocks are then machined into 4 cm thick cylinders. Following irradiation under mechanical deformation, the cylinders are machined into approximately 2 mm thick sections. Although the PE blocks disclosed by Muratoglu are generally polycrystalline, the crystals are generally randomly oriented. As a result, after the irradiated cross-linking process disclosed by Muratoglu, the resulting machined PE remains polycrystalline having no preferred orientation.

### SUMMARY OF THE INVENTION

A method for forming reduced creep high molecular weight polyethylene, includes the steps of providing at least one high molecular weight polyethylene fiber or block, the polyethylene being polycrystalline with a plurality of crystals having amorphous regions between the plurality of crystals. The fiber or block has a preferred crystal orientation. The fiber or block is irradiated in an environment including a molecule with a dual reactive functionality and an inert gas at a temperature that is below an average alpha transition temperature of the polyethylene, where the molecule with dual reactive functionality provides cross-links across the amorphous regions between adjacent ones of the plurality of crystals. The irradiating step can take place under isostatic pressure conditions. The molecule with a dual reactive functionality is a diene selected from the group consisting of R₁R₂C═CR₃R₄(CR₅R₆)ₓCR₇R₈═CR₉R₁₀, R₁C≡CR₂, and R₁R₂C≡CR₃═CR₄R₅, wherein R₁, R₂, R₃, R₄, R₅, R₅, R₇, R₈, R₉, and R₁₀ are independently selected from H, C₁ to C₄ alkyl and x is 0 to 4. The inert gas can be He.

The irradiation can take place at a temperature can be <50° C., or <0° C. A fiber with a diameter of less than 100 μm can be used. The resulting fiber or the block can provides an X-ray diffraction pattern evidencing only 2 sharp reflections. A radiation absorber can be included in the irradiation step to provide high relative cross-section for photoionization or radical formation from radiation. The radiation absorber is an element or molecule includes that includes at least one element having an atomic number of >15.

A method of grafting to high molecular weight polyethylene, includes the steps of providing at least one polyethylene fiber or block, the polyethylene being polycrystalline with a plurality of crystals, the plurality of crystals having a preferred crystal orientation, and grafting one or more grafting species at a temperature that is below an average alpha transition temperature of the polyethylene, where the grafting species becomes bound to a surface of the fiber. The one or more of the grafting species can be a molecule with a dual reactive functionality. The polyethylene fiber or block can be a plurality of the fibers, where the grafting specie provides cross-links between adjacent ones of the plurality of fibers. The method can be a peroxide initiated grafting method. The method can further include the steps of providing one or more grafting species in a solution, and irradiating the polyethylene suspended in the solution. Gamma rays, x-rays or electrons can be used for the irradiation. A radiation absorber can be included in the irradiation step to provide high relative cross-section for photoionization or radical formation from radiation.

A polyethylene article comprises at least one high molecular weight highly cross linked polyethylene fiber or block comprising a plurality of substantially aligned crystals. The fiber or block provides an X-ray diffraction pattern evidencing only 2 sharp reflections. The highly cross linked fiber or block is formed by irradiating a high molecular weight polyethylene fiber or block having a plurality of crystals having amorphous regions therebetween, the plurality of crystals having a preferred crystal orientation, in an environment including a molecule with a dual reactive functionality and an inert gas at a temperature that is below an average alpha transition temperature of the polyethylene, wherein the molecule with a dual reactive functionality provides a plurality of cross-links across the amorphous regions between adjacent ones of the plurality of crystals.

The highly cross linked polyethylene can include at least one grafting species bound to a surface of the highly cross linked polyethylene. The grafting specie can provide an unbound reactive group.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a schematic showing a molecular basis believed to be associated with creep in UHMWPE.

FIG. 2(a)-(c) are schematics showing an initial fiber, the fiber after elongation (creep), and the fiber after a creep rupture failure, respectively, according to a mechanism believed to be responsible for creep rupture in UHMWPE fibers.

FIG. 3 shows schematics of steps according to the invention which are believed to result in lengthening of UHMWPE Chains.

### DETAILED DESCRIPTION OF THE INVENTION

The invention describes low temperature methods for cross-linking as well as grafting high molecular weight polyethylene. As used herein, “high molecular weight” refers to an average molecular weight of at least 100,000 g/mol. In a first inventive embodiment, a method for forming reduced creep high molecular weight polyethylene articles comprises the steps of providing at least one high molecular weight polyethylene fiber or block, the polyethylene being polycrystalline comprising a plurality of crystals having amorphous regions therebetween. The plurality of crystals have a preferred crystal orientation. The polyethylene is irradiated in an environment including a molecule with a dual reactive functionality (e.g. diene) and an inert or unreactive gas at a temperature that is below an average alpha transition temperature of the polyethylene, wherein the diene provides cross-links across the amorphous regions between adjacent ones the plurality of crystals. The high level of cross-linking achieved between crystals comprising the polycrystalline fiber provides substantially improved wear resistance known to result from cross-linking, while overcoming the deficiency of earlier work by substantially maintaining the elastic modulus of the material resulting in creep resistance required for many applications which results from the annealing process used for the cross-linking.

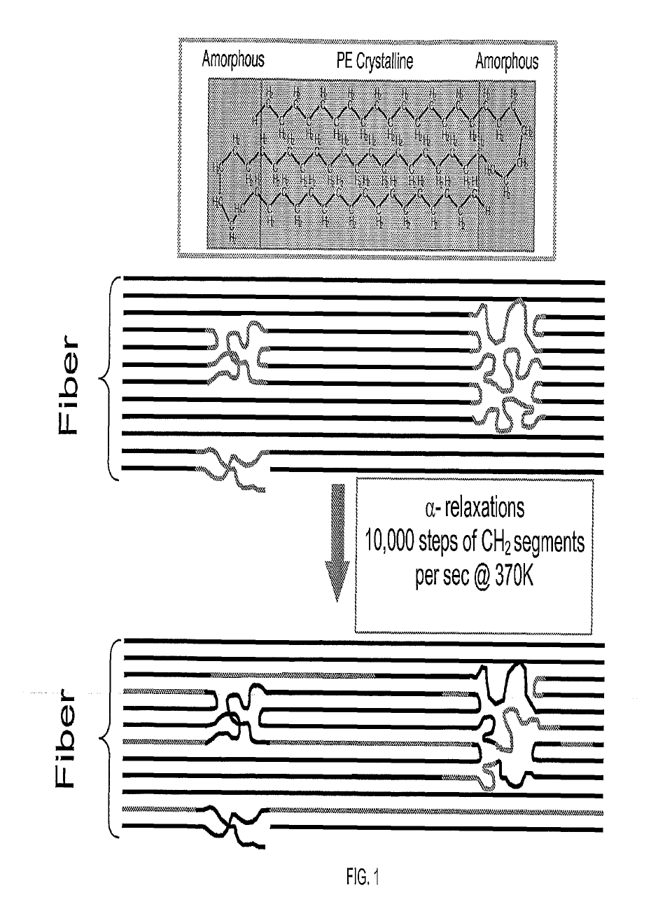

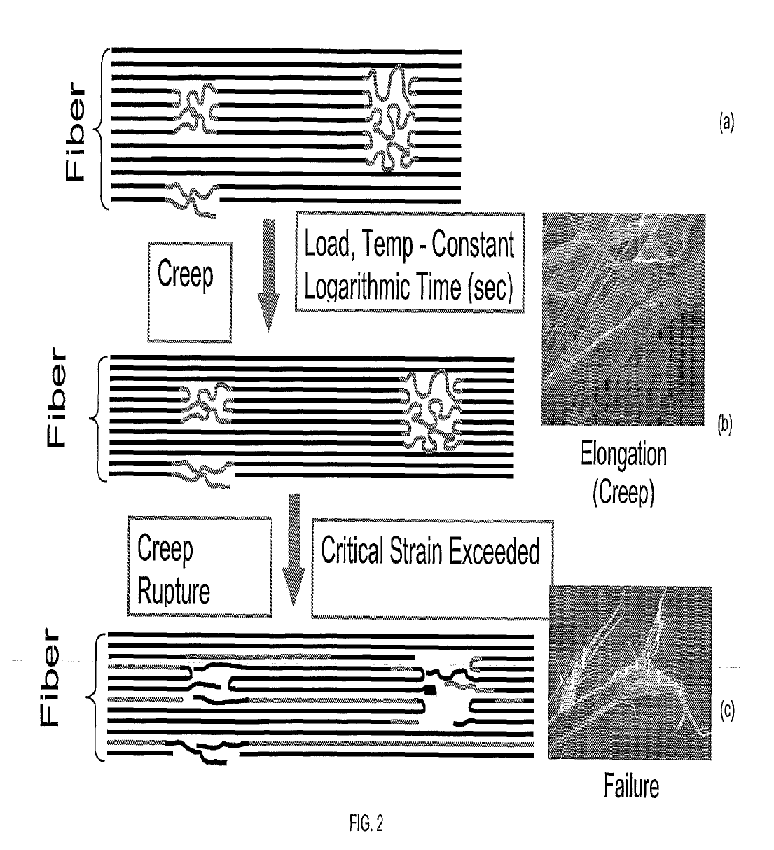

Although not required to practice the claimed invention, Applicant, not seeking to be bound by the mechanisms associated with the invention, provides the following. FIG. 1 shows a schematic showing a molecular basis believed to be associated with creep in UHMWPE. The UHMWPE fiber shown at the molecule chain scale includes a plurality of highly aligned CH₂ repeating units which are crystalline regions. At the ends of crystalline regions are amorphous, disordered domains. These amorphous domains are primarily responsible for connecting adjacent crystalline regions. Being above the a transition temperature, the amorphous domains are rapidly moving permitting a relaxations, such that 10,000 steps of CH₂ segments per second at 370 K occurs. FIG. 2(a)-(c) are schematics showing an initial fiber, the fiber after elongation (creep), and the fiber after a creep rupture failure, respectively, according to a mechanism believed to be responsible for creep rupture in UHMWPE fibers. The schematics show the amorphous PE domains determining the creep performance of the conventional UHMWPE fiber.

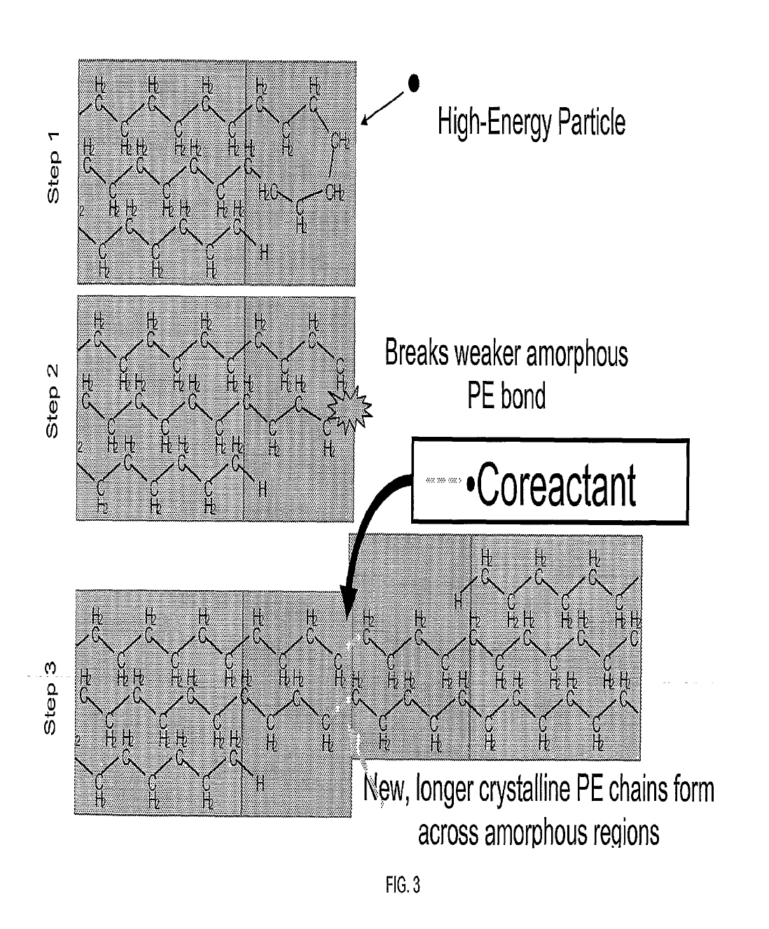

FIG. 3 shows schematics of steps according to the invention which are believed to cross-link across amorphous regions and result in lengthening of UHMWPE chains. Acetylene, with its C₂H₂ molecular structure, is a gas that could be used to form bonds to cross-link polyethylene. Introduced into the amorphous regions inside a UHMWPE fiber substantially contemporaneously with bond breaking of amorphous PE bond following an irradiation process, acetylene (the co-reactant) can covalently bond adjacent crystalline regions. In step 1, irradiation is directed at the PE fiber, the PE fiber being held at a temperature below the alpha transition temperature of PE. Being performed at a temperature below the alpha transition temperature there is effectively no diffusion by the amorphous segments into the crystals or vice versa. Thus, the chains are effectively locked into a conformation that enhances the probability of cross-linking. No mechanical force is required during any of the steps of the inventive method.

Step 2 shows the high energy particle breaking the weaker amorphous PE bond. The introduction of acetylene following irradiation, shown in step 3, adds bonds across the amorphous regions which couple adjacent crystalline PE domains. Such bonds are believed to be important for improving the creep properties of UHMWPE fibers, as a great deal of chain slippage is believed to occur within the amorphous regions. The resulting fiber or block following irradiation according to the invention can have sufficient orientation and crystallinity to provide an X-ray diffraction pattern evidencing only 2 sharp reflections.

However, the effectiveness of the cross-linking agents generally depends on the ability of the gas to diffuse into the amorphous regions of the polyethylene fiber. It is known that while irradiation in acetylene can decrease the cross-linking efficiency in polyethylene, irradiation in an acetylene-nitrogen mixture can actually improve the efficiency compared to a vacuum. Furthermore, the use of helium as the irradiating atmosphere decreases the activation energy of permeation into polyethylene compared to nitrogen gas. Helium also has a much higher diffusivity value (nearly an order of magnitude greater) than nitrogen gas. Therefore, there is great potential for the use of an acetylene-helium mixture as the irradiating atmosphere for UHMWPE fibers. If such a mixture can improve the cross-linking efficiency while providing covalent bonds deep into the amorphous regions of the fiber, creep properties should be improved with little or no loss (and possibly with some gain) in tensile properties. Depending on reaction conditions, cross-linking can be limited to the surface of the fibers or for cross-linking the macrofibrils that comprise a single filament together to form a single cross-linked bundle of macrofibrils.

The high molecular weight polyethylene is preferably UHMWPE, defined herein as having a molecular weight of at least 500,000 g/mol, preferably being at least 1,000,000 g/mol. In yet another alternative embodiment, the molecular weights are above about 2,000,000 g/mol. In still another alternative embodiment, the molecular weights are above about 4,000,000 g/mol, or more. The preferred crystal orientation UHMWPE is preferably in the form of fibers, such as gel-spinning derived SPECTRA™ fibers. Only about 2-3% of such fibers comprise amorphous regions. While repeating units in the amorphous regions make up a small volume fraction of UHMWPE fibers, their kinetics above the glass transition temperature play a significant role in the mechanical properties. In fact, it has been estimated that between 70 and 110° C., polyethylene molecules diffuse into and out of the crystalline regions more than 10,000 times per second. This fast motion is believed by the inventors to make it difficult to cross-link molecules within the amorphous regions.

Also, it becomes increasingly difficult to eliminate excess free radicals from polyethylene when the radicals are diffusing between crystalline and amorphous regions just as quickly as the molecules. Excess free radicals will begin to oxidize and degrade the polyethylene if not consumed via cross-linking. To combat this difficulty, some have heated their post-irradiation samples near or in excess of the 140-145° C. degree melt temperature of UHMWPE. This heat treatment is said to speed up the kinetics within the bulk material and, ideally, allow all of the remaining free radicals to react with the polyethylene. However, heat treatments at temperatures of about 90° C. or more can significantly reduce the modulus of the fibers, due to onset of melting.

The invention does not follow conventional methods, as polyethylene that approaches its melt temperature begins to lose the high crystallinity and orientation that provide the outstanding mechanical properties associated with this material. Thus, the invention provides irradiation below an average alpha transition temperature of the polyethylene, such as <50 C, including <0 C, and even at a cryogenic temperature range including <−150° C. to −200° C. Moreover, the irradiation is preferably performed under isostatic conditions.

The high molecular weight polyethylene may be, in one embodiment, polyethylene that is characterized in that its repeat unit is essentially ethylene, although, in other embodiments, it may be a copolymer thereof with small amounts of other monomers such as α-olefin, acrylic acid or derivatives thereof, methacrylic acid or derivatives thereof or vinyl silane or derivatives thereof, or it may be a copolymer with these, or a copolymer with ethylene homopolymer, or it may be a blend with homopolymers of other α-olefins and the like.

As noted above, the dual reactive functionality is generally a diene. Dienes by definition are compounds that contain two fixed double bonds, traditionally implied to be between two different pairs of carbon atoms, are examples of species which provide at least a dual reactive functionality. Dienes according to the invention include conjugated dienes which have the two double-bond units linked by one single bond are termed conjugated, e.g. dienes such CH₂═CH—CH═CH₂ which is buta-1,3-diene, as well as isoprene, and 4-methyl pentadiene. Acetylene and other alkynes, although not traditionally defined as a dienes since the two pi bonds are situated between the same pair of carbon atoms, has dual reactive functionality. In like manner, allenes, where the pi bonds share one common carbon can be used as the dual reactive functionality. Examples of other species include triallyl isocyanurate, peroxides, cyclopropane (and its derivatives), and cyclobutane (and its derivatives). Other agents can also include epoxy containing species and di-ynes. Organic azides will also likely be effective agents since they generate a nitrene which is difunctional. Under certain circumstances, a mono-ene (olefin) can effectively provide dual functionality (such as in polyethylene polymerization) when two radicals formed by addition of a mono-ene to a radical on the polyethylene tend to terminate by coupling rather than disproportionating.

The irradiation can comprise any high energy radiation that initiates the desired cross-linking reaction within the fiber. In one embodiment, gamma irradiation may be used, such as ⁶⁰Co radiation. In another embodiment, x-ray radiation may be used. In still another embodiment, electron irradiation may be used.

The irradiation dose may be varied to control the degree of cross-linking and crystallinity in the final fiber composition. In one embodiment, a dose of greater than about 1 kGy is used. In an alternative embodiment, a dose of greater than about 20 kGy is used. When electron irradiation is used, the energy of the electrons may be varied to change the depth of penetration of the electrons, thereby controlling the degree of penetration of cross-linking in the final product. In one embodiment, the energy is from about 0.5 MeV to about 10 MeV. In another embodiment, the energy is from about 5 MeV to about 10 MeV.

In another embodiment of the invention, the molecule with a dual reactive functionality cross-linking process across the amorphous regions between adjacent crystals in UHMWPE and related fibers can be enhanced by using a molecule with a higher atomic number element (e.g. Z>15, preferably Z>25) to act as a radiation absorber to provide high relative cross-section for photoionization or radical formation from radiation. The dual reactive molecule is preferably non-polar for entry into the amorphous zones of the fiber to permit solubility in linear hydrocarbons, such as heptane, and a small enough molecular size to diffuse readily into the solid polymer. The radiation absorber can also be a molecule which absorbs the radiation and generates a radical or other reactive species and subsequently transfers the radical to the polyethylene or the molecule with a dual reactive functionality.

Some exemplary higher atomic number radiation absorbers include barium alkylates, HI or HBr, silane and chloroform. These radiation absorbers are used with at least one molecule with a dual reactive functionality, such as the mixture of isoprene and silane. However, it is likely a radiation absorbers with high z (e.g. I₂ or HI) alone may diffuse into the amorphous zone and act as a trigger of free-radical formation (multiple) and consequently create a multi-functional reaction. Materials generated by these radiation absorbers will generally provide a higher concentration of cross-links in the amorphous region. In this embodiment, diffusion can be enhanced through modest heating, or through mechanical agitation such as ultrasound or cyclic stretching. In addition to ionizing radiation, visible or UV radiation can be used in a similar fashion with suitable initiators and/or sensitizers.

In another embodiment of the invention, the fiber surface is modified by adding a grafting specie which preferably generally provides dual reactive functionality, such as a diene, on the surface of a UHMWPE fiber. This method provides cross-linking on the external surface of the individual filaments, fibrils and macrofibrils into a more uniform single body. However, the invention includes grafting species having single reactive functionality that are thus unable to cross-link. This process can proceed at room temperature and without irradiation. Appropriate surface grafts can provide desired fiber characteristics, electroactivity, including, but not limited to, wetting, gas permeability, and oxidative stability. Significantly, when the preferred grafting specie having dual reactive functionality is provided, the remaining reactive group after the graft also allows the grafted fiber to participate in subsequent chemical reactions. The grafting specie is grafted in an amount of from about 1 to about 10% by weight of the total composition.

The non-diene grafting specie can be a mono-ene, such as an acrylic monomer. The grafting specie can also include macromers. Subsequently chemical reaction to grafting on the polyethylene can results in cross-linking by coupling two grafts on two fibers. Cross-linking between fibers helps limit fiber-to-fiber creep.

The grafting method used can be based on the hydroperoxide initiated grafting method which permits the grafting of tethered, linear chains by a free radical-type polymerization disclosed in a PhD dissertation by Jesse J. Arnold entitled “METHODS OF FIBER SURFACE GRAFTING FOR INTERPHASE DESIGN AND TAILORED COMPOSITE RESPONSE” which was published in 1997 and available in the University of Florida Library. Hydroperoxide initiated grafting does not require irradiation, but is generally wet chemical method. In the Arnold thesis, the grafting moieties, such as acrylamide and acrylic acid, all lacked diene functionality. As a result, the grafts disclosed by Arnold cannot provide the cross-linking or a reactive surface provided by the preferred embodiment of this aspect of the invention, but must rely either upon a secondary processing method or upon a change in composition to substitute the diene for a vinyl compound/monomer.

An embodiment of the invention involves the irradiation of UHMWPE fibers while being drawn through a solution of one or more grafting specie where a preferred solution includes at least one diene as defined for the purposes of the invention. Irradiation is carried out with gamma-rays, x-rays or electrons. Particularly when the solvent, grafting species, and/or an included radiation absorber includes one or more atoms with an atomic mass or >15, a larger proportion of the reactive species, such as radicals, are generated at the surface rather than within the bulk of the fiber unlike the case for irradiation of a fiber in a gaseous environment. Where the radicals and other reactive species are created in the bulk of the fiber, polymer chain scission can dominate cross-linking, particularly in crystalline regions of the fiber where a grafting agent's or diene's penetration is relatively poor. In this manner polymer chain scission within the fiber can be minimize. It is known that when chain scission dominant over cross-linking; creep properties can be compromised rather than enhanced by irradiation. The irradiation of the fiber in a liquid promotes the grafting, polymerization and cross-linking of the diene on the surface of the polyethylene fiber. By biasing the radical or other reactive species formation to the surface the filling of defects including voids and strengthening of the amorphous regions that are in contact with the surface via the formation of a cross-linked structure occurs preferentially to any molecular weight degrading processes within the fibers. Defects, and in particular surface defects, can have a large contribution to the observed creep properties of a fiber.

The invention provides numerous advantages over the available art. The invention can be used to control the cross-link density and maintain both the high modulus (stiffness) and strength that are critical in many applications. In addition, by eliminating the high temperature annealing step, the processing times and procedures are simplified. Finally, the invention can be used for “net-shape” devices. These are devices that have been either molded or machined to a finished dimension.

Products which can benefit from the invention include reinforcement fibers for a high altitude air ships, reinforcement fibers for bullet proof vests (Personal protection wovens). Other products that can benefit from the invention include medical implants such as wear surfaces on hip prostheses, knee prostheses, elbow prosthesis and spinal implants. Various manufacturers of polyethylene or polypropylene suture materials can also benefit from the invention.

### EXAMPLE

It should be understood that the prophetic Examples described below are provided for illustrative purposes only and do not in any way define the scope of the invention.

### Formation of Low Creep UHMWPE Fibers

SPECTRA® UHMPE fibers (Allied Signal) were obtained. SPECTRA® has a reported melting point of 150° C. The diameter of the fibers was about 40 μm. The fibers were irradiated for 84 hours at a dose rate of 140 rads/min for a total dose of 0.1 Mrad. The gas mixture was about 3% by volume acetylene and about 97% by volume He. The process temperature was 25° C. The resulting fibers after irradiation processing had a highly preferred crystal orientation evidenced by an X-ray diffraction pattern which revealed on two (2) sharp reflections.

It is to be understood that while the invention has been described in conjunction with the preferred specific embodiments thereof, that the foregoing description as well as the examples which follow are intended to illustrate and not limit the scope of the invention. Other aspects, advantages and modifications within the scope of the invention will be apparent to those skilled in the art to which the invention pertains.

1. A method for forming reduced creep high molecular weight polyethylene, comprising the steps of
providing at least one high molecular weight polyethylene fiber or block, said polyethylene being polycrystalline comprising a plurality of crystals having amorphous regions therebetween, said plurality of crystals having a preferred crystal orientation, and
irradiating said polyethylene in an environment including a molecule with a dual reactive functionality and an inert gas at a temperature that is below an average alpha transition temperature of said polyethylene, wherein said molecule with a dual reactive functionality provides cross-links across said amorphous regions between adjacent ones of said plurality of crystals.

2. The process of claim 1, wherein said irradiating step takes place under isostatic pressure conditions.

3. The method of claim 1, wherein said molecule with a dual reactive functionality is a diene selected from the group consisting of R₁R₂C═CR₃R₄(CR₅R₆)ₓCR₇R₈═CR₉R₁₀, R₁C≡CR₂, and R₁R₂C═CR₃═CR₄R₅, wherein R₁, R₂, R₃, R₄, R₅, R₆, R₇, R₈, R₉, and R₁₀ are independently selected from H, C₁ to C₄ alkyl and x is 0 to 4.

4. The method of claim 1, wherein said inert gas comprises He.

5. The method of claim 1, wherein said temperature is <50 C.

6. The method of claim 1, wherein said temperature is <0 C.

7. The method of claim 1, wherein a diameter of said fiber is less than 100 μm.

8. The method of claim 1, wherein said fiber or said block after said irradiating step provides an X-ray diffraction pattern evidencing only 2 sharp reflections.

9. The method of claim 1, wherein a radiation absorber is included in said irradiation step to provide high relative cross-section for photoionization or radical formation from radiation.

10. The method of claim 9, wherein said radiation absorber includes at least one element having an atomic number of >15.

11. A method of grafting to high molecular weight polyethylene, comprising the steps of:
providing at least one polyethylene fiber or block, said polyethylene being polycrystalline comprising a plurality of crystals, said plurality of crystals having a preferred crystal orientation, and
grafting one or more grafting species at a temperature that is below an average alpha transition temperature of said polyethylene, wherein said grafting species becomes bound to a surface of said fiber.

12. The method of claim 11, wherein one or more of said grafting species is a molecule with a dual reactive functionality.

13. The method of claim 11, wherein said at least one polyethylene fiber or block comprises a plurality of said fibers, wherein said grafting specie provides cross-links between adjacent ones of said plurality of fibers.

14. The method of claim 11, wherein said method comprises a peroxide initiated grafting method.

15. The method of claim 11, further comprising the steps of:
providing said one or more grafting species in a solution, and
irradiating said polyethylene suspended in said solution.

16. The method of claim 15, wherein irradiation is by gamma rays, x-rays or electrons.

17. The method of claim 15, wherein a radiation absorber is included in said irradiation step to provide high relative cross-section for photoionization or radical formation from radiation.

18. A polyethylene article, comprising:
at least one high molecular weight highly cross linked polyethylene fiber or block comprising a plurality of substantially aligned crystals, said fiber or block providing an X-ray diffraction pattern evidencing only 2 sharp reflections, said highly cross linked fiber or block formed by:
irradiating a high molecular weight polyethylene fiber or block having a plurality of crystals having amorphous regions therebetween, said plurality of crystals having a preferred crystal orientation, in an environment including a molecule with a dual reactive functionality and an inert gas at a temperature that is below an average alpha transition temperature of said polyethylene, wherein said molecule with a dual reactive functionality provides a plurality of cross-links across said amorphous regions between adjacent ones of said plurality of crystals.

19. The article of claim 18, wherein said highly cross linked polyethylene includes at least one grafting species bound to a surface of said highly cross linked polyethylene.

20. The article of claim 19, wherein said grafting specie provides an unbound reactive group.
